(19) United States
(12) Patent Application Publication
(10) Pub. No.: US 2006/0256076 A1
(43) Pub. Date: Nov. 16, 2006

(54) Interactive system with movement sensing capability

(75) Inventors: Shun-Nan Liou, Kaohsiung City (TW); Ming-Jye Tsai, Zhubei City (TW); Yu-Hung Cheng, Pingtung City (TW); Ying-Ko Lu, Guishan Shiang (TW); Hsiang-Yu Huang, Tainan City (TW); Yung-Yu Chen, Xinyuan Shiang (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 11/190,133

(22) Filed: Jul. 27, 2005

(30) Foreign Application Priority Data
May 13, 2005 (TW) 94115699

(51) Int. Cl. G09G 5/00

(52) U.S. Cl. 345/156

(57) ABSTRACT

An interactive system with movement sensing capability, comprising: an inertial sensing unit disposed on a movable object so as to sense a movement of the movable object and generate a corresponding signal; a control unit connected to the inertial sensing unit so as to transmit the signal; and a multi-media unit receiving the signal so as to display a corresponding first image and a second image interacted with the first image.

### BACKGROUND OF THE INVENTION

1. Field of the Invention

The present invention generally relates to an interactive system with movement sensing capability and, more particularly, to an interactive system with movement sensing capability, capable of sensing variance of movement so as to interact with images on a multi-media platform.

2. Description of the Prior Art

Virtual reality (VR) integrates 3-D computer graphics, 3-D audio and an interface for sensing thereof so as to create a virtual environment, in which people can interact with the environment in real time. Here, “real time” indicates that the hardware system can sense and/or detect the movement of the user and then enables the environment to react in response to the movement of the user, so that the users feel like they are in the virtual environment.

The hardware system for virtual reality comprises a VR management unit, a tracer, and a data input device. For the data input device, even though technologies for optical image access and users interfaces have become mature, the price is still too high to make VR system popularized.

Conventionally, most interactive systems are implemented using optics and video processing technologies. For example, U.S. Pat. No. 5,534,917 discloses a video image based control system as shown in FIG. 1. The 3-D VR based game device using a video camera for retrieving data representing the human movement outperforms the most currently used game devices that employ a joystick with a keyboard. However, U.S. Pat. No. 5,534,917 requires a plurality of video cameras in practical uses, therefore the cost is very high and complexity of setting up of this system increases. On the contrary, if only a video camera is used, the resolution could be quite poor.

Moreover, EP No. 1,137,978 B1 discloses a device indicating movements for software using movement sensors (on/off sensors) in video games as shown in FIG. 2. In FIG. 2, sleeves 21d, 21g, 41d and 41g for fitting around the joints and on/off sensors 20d, 20g, 40d and 40g fixed to the sleeves respectively are provided. When the human body moves heavily, data indicating the movement is transmitted via the movement sensors (on/off sensors) to the game device. However, the on/off sensors only provide with either on or off state and cannot sense how the body moves continuously. On the other hand, the movement sensors suffer from poor sensitivity. For example, in a fistfight game, the sensors cannot sense how slight the force from the players is and therefore mislead the players.

Therefore, there is need in providing an interactive system with movement sensing capability to overcome the problems that appear in the prior art.

### SUMMARY OF THE INVENTION

It is a primary object of the present invention to provide an interactive system with movement sensing capability, integrating technologies of sensors, control systems and 3-D graphics so as to achieve sportiveness, entertainments and interactiveness.

It is a secondary object of the present invention to provide an interactive system with movement sensing capability, capable of reducing power consumption using kinetic energy of a user as electricity required by the interactive system.

In order to achieve the foregoing objects, the present invention provide an interactive system with movement sensing capability, comprising:

an inertial sensing unit disposed on a movable object so as to sense a movement of the movable object and generate a corresponding signal;

a control unit connected to the inertial sensing unit so as to transmit the signal; and

a multi-media unit receiving the signal so as to display a corresponding first image and a second image interacted with the first image.

It is preferable that the control unit comprises a signal transformer and a signal transmission module, the signal transformer being electrically connected to the inertial sensing unit and the signal transmission module so as to receive and process the signal generated by the inertial sensing unit.

It is preferable that the multi-media unit generates and displays the first image on a display.

It is preferable that the display is one selected from a group comprising a computer, a television, a cell phone, a personal digital assistant, and a projector.

It is preferable that the control unit transmits the signal by wireless transmission.

It is preferable that the movable object is a human body.

It is preferable that the inertial sensing unit comprises at least a single-axis inertial sensor.

It is preferable that the inertial sensing unit comprises at least a multi-axis inertial sensor.

It is preferable that the inertial sensing unit comprises at least a single-axis inertial sensor and a multi-axis inertial sensor.

It is preferable that the inertial sensing unit comprises at least an accelerometer.

It is preferable that the inertial sensing unit comprises at least a gyroscope.

It is preferable that the inertial sensing unit comprises at least an accelerometer and a gyroscope.

It is preferable that the interactive system with movement sensing capability further comprises a micro power generator capable of transforming kinetic energy of the movable object into electricity, the micro power generator being connected to a power supply so as to provide electricity for the inertial sensing unit and the control unit.

It is preferable that the signal is an acceleration signal of the movable object.

It is preferable that the signal is an angular velocity of the movable object.

It is preferable that the signal is an acceleration signal and an angular velocity signal of the movable object.

It is preferable that the multi-media unit is one selected from a group comprising a game media, a large-size game station and a personal computer.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a conventional interactive system in accordance with the prior art;

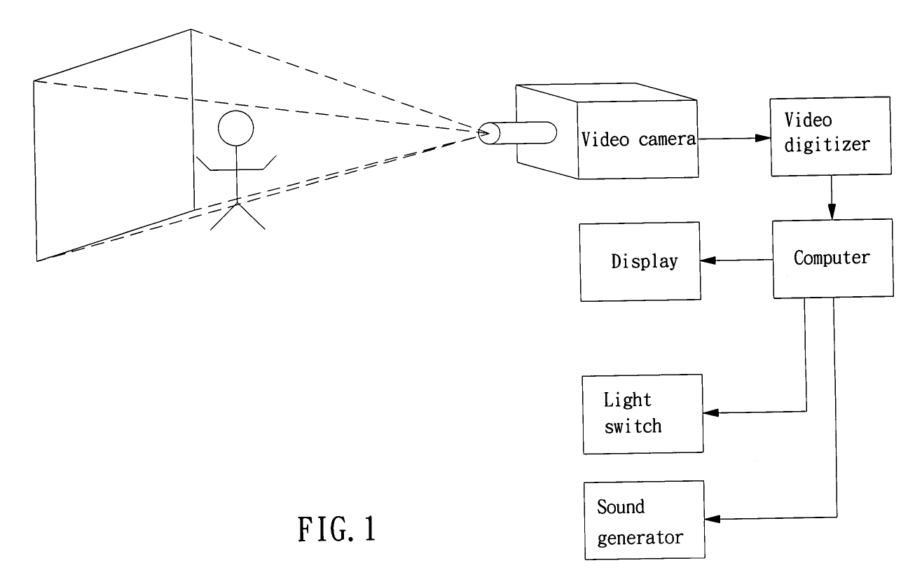

FIG. 2 is another conventional interactive system in accordance with the prior art;

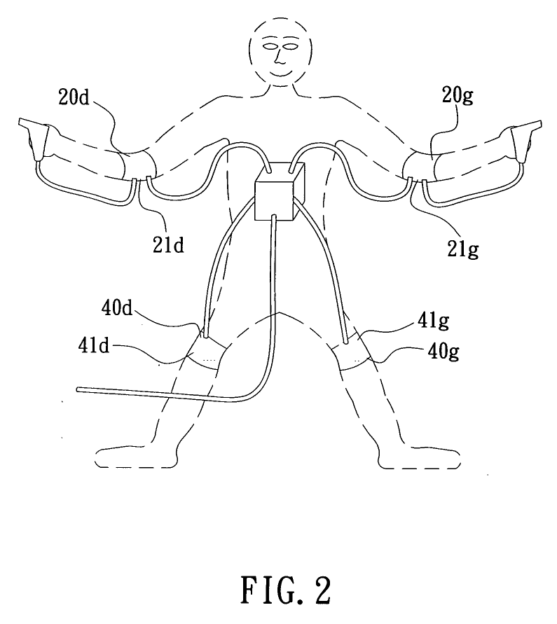

FIG. 3 is a schematic diagram showing an interactive system with movement sensing capability in accordance with one embodiment of the present invention; and

FIG. 4 is a flow chart showing the operation of an interactive system with movement sensing capability in accordance with one embodiment of the present invention.

### DETAILED DESCRIPTION OF THE PREFERRED EMBODIMENT

The present invention providing an interactive system with movement sensing capability can be exemplified by the preferred embodiment as described hereinafter.

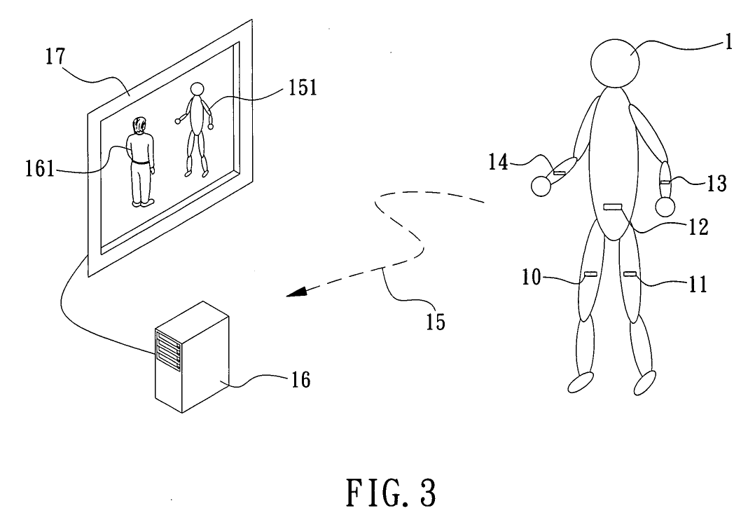

Please refer to FIG. 3, which is a schematic diagram showing an interactive system with movement sensing capability in accordance with one embodiment of the present invention. In FIG. 3, the user 1 is provided with a plurality of inertial sensing units 10, 11, 12, 13 and 14 for sensing a movement of the user 1 and generating a corresponding signal 15. The signal 15 is then transmitted to a multi-media unit 16 via wireless transmission. The multi-media unit 16 is electrically connected to a display 17 and generates a program image 161. When the multi-media unit 16 receives the signal 15, a virtual image 151 is generated in response to the movement of the user 1. Therefore, the user 1 interacts with the program image 161 through the display 17, for example, fistfight, boxing, wrestling games.

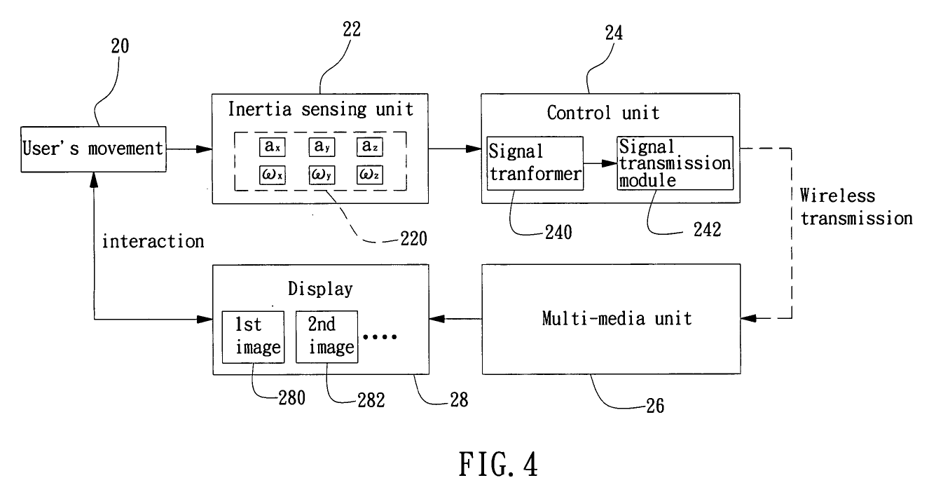

FIG. 4 is a flow chart showing the operation of an interactive system with movement sensing capability in accordance with one embodiment of the present invention. In FIG. 4, the user's movement 20 activates an inertial sensing unit 22 to generate a signal 220 indicating acceleration along x-axis, y-axis and z-axis (aₓ, a_{y}, a_{z}) and angular velocity along x-axis, y-axis and z-axis (ωₓ, ω_{y}, ω_{z}).

The signal 220 is transmitted to a control unit 24, which is connected to the inertial sensing unit 22. The control unit 24 comprises a signal transformer 240 and a signal transmission module 242, which transmits through wireless transmission. The signal transformer 240 receives and transforms the signal 220 from the inertial sensing unit 22 and then the signal transmission module 242 transmits the transformed signal.

Then, a multi-media unit 26 receives the transformed signal and displays a corresponding first image 280 on a display 28. The display 28 further displays a second image 282 (such as a program image generated by the multi-media unit 26). Therefore, the user enables the first image 280 (corresponding to the user's movement 20) to interact with the second image 282 so as to achieve entertainment or learning purpose.

Moreover, the interactive system of the present invention further comprises a micro power generator (not shown) capable of transforming kinetic energy of the movable object into electricity. The micro power generator is connected to a power supply (not shown) so as to provide electricity for the inertial sensing unit and the control unit. The inertial sensing unit and the micro power generator are implemented by using micro-electro-mechanical system (MEMS) technology, which largely reduce the size and is easy to use.

In the present invention, the multi-media unit is one selected from a group comprising a game media, a large-size game station and a personal computer. The display is one selected from a group comprising a computer, a television, a cell phone, a personal digital assistant, and a projector. The movable object is preferably a human body. However, in the present, the preferred embodiment is only exemplary but not thus limited. The interactive system of the present invention is applicable to any movable object. Moreover, the inertial sensing unit comprises at least a single-axis inertial sensor or a multi-axis inertial sensor. Alternatively, the inertial sensing unit comprises at least a single-axis inertial sensor and a multi-axis inertial sensor. The inertial sensing unit comprises at least an accelerometer or a gyroscope. Alternatively, the inertial sensing unit comprises at least an accelerometer and a gyroscope.

Accordingly, it is apparent that the present invention discloses an interactive system with movement sensing capability that employs an inertial sensing unit to sense a human body's movement on different portions and characterize the movement by angular velocities and accelerations. Unlike the prior art using movement sensors (on/off sensors) to only determine whether the movable object moves or not, the present invention provides better interaction and reduced cost and size by using MEMS technology. On the other hand, the compact design as well as wireless transmission makes the interactive system of the present invention easy to carry with. Therefore, the present invention is novel, useful and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. An interactive system with movement sensing capability, comprising:
an inertial sensing unit disposed on a movable object so as to sense a movement of said movable object and generate a corresponding signal;
a control unit connected to said inertial sensing unit so as to transmit said signal; and
a multi-media unit receiving said signal so as to display a corresponding first image and a second image interacted with said first image.

2. The interactive system with movement sensing capability as recited in claim 1, wherein said control unit comprises a signal transformer and a signal transmission module, said signal transformer being electrically connected to said inertial sensing unit and said signal transmission module so as to receive and process said signal generated by said inertial sensing unit.

3. The interactive system with movement sensing capability as recited in claim 1, wherein said multi-media unit generates and displays said first image on a display.

4. The interactive system with movement sensing capability as recited in claim 3, wherein said display is one selected from a group comprising a computer, a television, a cell phone, a personal digital assistant, and a projector.

5. The interactive system with movement sensing capability as recited in claim 1, wherein said control unit transmits said signal by wireless transmission.

6. The interactive system with movement sensing capability as recited in claim 1, wherein said movable object is a human body.

7. The interactive system with movement sensing capability as recited in claim 1, wherein said inertial sensing unit comprises at least a single-axis inertial sensor.

8. The interactive system with movement sensing capability as recited in claim 1, wherein said inertial sensing unit comprises at least a multi-axis inertial sensor.

9. The interactive system with movement sensing capability as recited in claim 1, wherein said inertial sensing unit comprises at least a single-axis inertial sensor and a multi-axis inertial sensor.

10. The interactive system with movement sensing capability as recited in claim 1, wherein said inertial sensing unit comprises at least an accelerometer.

11. The interactive system with movement sensing capability as recited in claim 1, wherein said inertial sensing unit comprises at least a gyroscope.

12. The interactive system with movement sensing capability as recited in claim 1, wherein said inertial sensing unit comprises at least an accelerometer and a gyroscope.

13. The interactive system with movement sensing capability as recited in claim 1, further comprising a micro power generator capable of transforming kinetic energy of said movable object into electricity, said micro power generator being connected to a power supply so as to provide electricity for said inertial sensing unit and said control unit.

14. The interactive system with movement sensing capability as recited in claim 1, wherein said signal is an acceleration signal of said movable object.

15. The interactive system with movement sensing capability as recited in claim 1, wherein said signal is an angular velocity signal of said movable object.

16. The interactive system with movement sensing capability as recited in claim 1, wherein said signal is an acceleration signal and an angular velocity signal of said movable object.

17. The interactive system with movement sensing capability as recited in claim 1, wherein said multi-media unit is one selected from a group comprising a game media, a large-size game station and a personal computer.
